(19) United States
(12) Patent Application Publication
(10) Pub. No.: US 2009/0280960 A1
(43) Pub. Date: Nov. 12, 2009

(54) Stepped Exercising and Electricity Generating Machine

(76) Inventor: Peng Feng Tian, Dongguan City (CN)

Correspondence Address: Dr. BANGER SHIA;Int''l Patent Office of Bang Shia, 102 Lindencrest Ct, Sugar Land, TX, 77479-5201, US

(21) Appl. No.: 12/356,141

(22) Filed: Jan. 20, 2009

(30) Foreign Application Priority Data
May 9, 2008 (CN) 200820200066.5

(51) Int. Cl. F03G 5/00

(52) U.S. Cl. 482/2; 290/50

(57) ABSTRACT

A stepped exercising and electricity generating machine includes two pedals, a transmission mechanism, and an electricity generator, the pedals being connected with the electricity generator through the transmission mechanism, characterized in that the stepped exercising and electricity generating machine further includes a frame having a housing disposed on the bottom thereof, in the housing are mounted a rechargeable battery and a DC/AC box, an input end of the rechargeable battery is electrically connected with an output end of the electricity generator and an output end of the rechargeable battery is electrically connected with an input end of the DC/AC box, an output end of the DC/AC box is coupled with a socket by using a wire, such that user can exercise to store energy and the stored energy can be used to supply power to the electrical product as using the electrical product.

### BACKGROUND OF THE INVENTION

1. Field of the Invention

The present invention relates to a stepped exercising and electricity generating machine that user can exercise to store energy and the stored energy can be used to supply power to the electrical product as using the electrical product.

2. Description of the Prior Art

Conventional stepped electricity generating machine is comprised of two pedals, a transmission mechanism, and an electricity generator. The pedals are connected with the electricity generator through the transmission mechanism, accordingly user has to step the pedals to generate energy while in use of the electrical product, causing the inconvenience which the user has simultaneously to step the pedals to generate energy while in use of the electrical product.

The present invention has arisen to mitigate and/or obviate the afore-described disadvantages.

### SUMMARY OF THE INVENTION

The primary objective of the present invention is to provide a stepped exercising and electricity generating machine that can prevent the inconvenience which the user has simultaneously to step the pedals to generate energy while in use of the electrical product.

The stepped exercising and electricity generating machine according to the present invention comprises: two pedals, a transmission mechanism, an electricity generator with a rotor therein, and a frame, the pedals being connected with the electricity generator through the transmission mechanism, so that as user steps the pedals, the rotor of the electricity generator is driven to rotate to generate energy. The frame includes a housing disposed on the bottom thereof, and in the housing are mounted a rechargeable battery to store the energy and a DC/AC box to transform direct current outputted from the rechargeable battery into alternating current. An input end of the rechargeable battery is electrically connected with an output end of the electricity generator and an output end of the rechargeable battery is electrically connected with an input end of the DC/AC box, and an output end of the DC/AC box is coupled with a socket by using a wire, the socket is provided to insert a variety of plugs of electrical appliance thereon. The frame includes a seat secured thereon so that the user can sit on the seat to step the pedals.

During stepping the pedals to exercise, the energy generated from the electricity generator is stored in the rechargeable battery so that the user can insert a plug of an electrical product onto the socket as desiring to use the electrical product. Therefore, the stepped exercising and electricity generating machine can be used to exercise to store energy and the stored energy can be used to supply power to the electrical product as using the electrical product, thus preventing the inconvenience which the user has simultaneously to step the pedals to generate energy while in use of the electrical product.

### BRIEF DESCRIPTION OF THE DRAWINGS

FIG. 1 is a perspective view of a stepped exercising and electricity generating machine in accordance with the present invention;

FIG. 2 is a perspective view of the stepped exercising and electricity generating machine in accordance with the present invention except housing.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

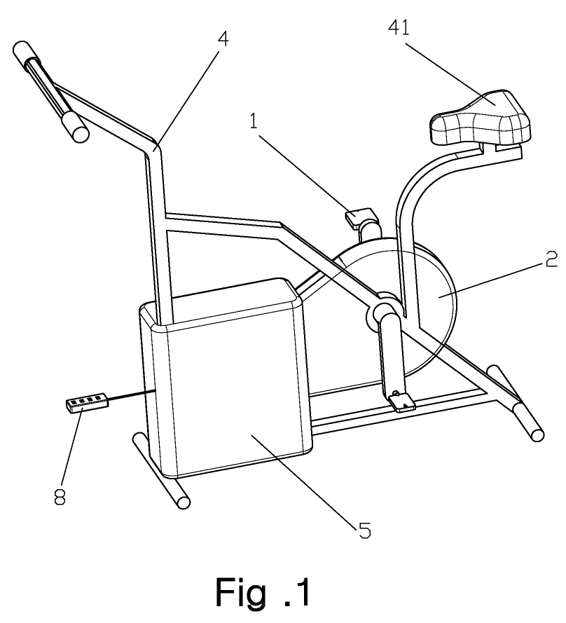

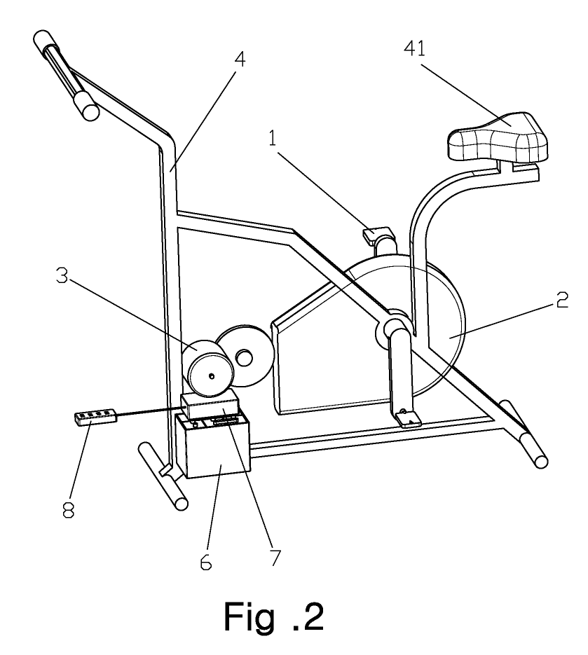

Referring to FIGS. 1 and 2, a stepped exercising and electricity generating machine in accordance with the present invention comprises: two pedals 1, a transmission mechanism 2, an electricity generator 3 with a rotor therein, and a frame 4, the pedals 1 being connected with the electricity generator 3 through the transmission mechanism 2, so that as user steps the pedals 1, the rotor of the electricity generator 3 is driven to rotate to generate energy. The frame 4 includes a housing 5 disposed on the bottom thereof, and in the housing 5 are mounted a rechargeable battery 6 to store the energy and a DC/AC box 7 to transform direct current outputted from the rechargeable battery 6 into alternating current. An input end of the rechargeable battery 6 is electrically connected with an output end of the electricity generator 3 and an output end of the rechargeable battery 6 is electrically connected with an input end of the DC/AC box 7, an output end of the DC/AC box 7 is coupled with a socket 8 by using a wire, the socket 8 is provided to insert a variety of plugs of electrical appliance thereon. The frame 4 includes a seat 41 secured thereon so that the user can sit on the seat 41 to step the pedals 1.

During stepping the pedals 1 to exercise, the energy generated from the electricity generator 3 is stored in the rechargeable battery 6 so that the user can insert a plug of an electrical product onto the socket 8 as desiring to use the electrical product. Therefore, the stepped exercising and electricity generating machine can be used to exercise to store energy and the stored energy can be used to supply power to the electrical product as using the electrical product, thus preventing the inconvenience which the user has simultaneously to step the pedals to generate energy while in use of the electrical product.

While we have shown and described various embodiments in accordance with the present invention, it is clear to those skilled in the art that further embodiments may be made without departing from the scope of the present invention.

What is claimed is:

1. A stepped exercising and electricity generating machine comprises two pedals, a transmission mechanism, and an electricity generator, the pedals being connected with the electricity generator through the transmission mechanism, characterized in that the stepped exercising and electricity generating machine further includes a frame having a housing disposed on the bottom thereof, in the housing are mounted a rechargeable battery and a DC/AC box, an input end of the rechargeable battery is electrically connected with an output end of the electricity generator and an output end of the rechargeable battery is electrically connected with an input end of the DC/AC box, an output end of the DC/AC box is coupled with a socket by using a wire.

2. The stepped exercising and electricity generating machine as claimed in claim 1, characterized in that the frame includes a seat secured thereon.
